(19) United States
(12) Patent Application Publication
(10) Pub. No.: US 2010/0092849 A1
(43) Pub. Date: Apr. 15, 2010

(54) BATTERY MODULE

(75) Inventors: Steven J. Wood, Shorewood, WI (US); Gary P. Houchin-Miller, Fox Point, WI (US); Dale B. Trester, Milwaukee, WI (US); Michael G. Andrew, Menomonee Falls, WI (US)

Correspondence Address: FOLEY & LARDNER LLP, 777 EAST WISCONSIN AVENUE, MILWAUKEE, WI, 53202-5306, US

(73) Assignee: JOHNSON CONTROLS-SAFT ADVANCED POWER SOLUTIONS LLC

(21) Appl. No.: 12/528,075

(22) PCT Filed: Dec. 21, 2007
(86) PCT No.: PCT/US07/88622

§ 371 Date: Aug. 20, 2009

Related U.S. Application Data
(60) Provisional application No. 60/904,179, filed on Mar. 1, 2007.

(51) Int. Cl. H01M 2/10; H01M 10/50

(52) U.S. Cl. 429/99; 429/120

(57) ABSTRACT

A battery module includes a housing configured to receive a plurality of cells. The housing includes a first tray that includes a plurality of depressions and a second tray coupled to the first tray that includes a plurality of depressions. Each of the plurality of cells is received within a depression of at least one of the first tray and the second tray.

### CROSS-REFERENCE TO RELATED APPLICATIONS

This application claims priority to and the benefit of U.S. patent application Ser. No. 60/904,179, filed Mar. 1, 2007, the entire disclosure of which is incorporated herein by reference in its entirety.

### STATEMENT OF GOVERNMENT RIGHTS

This invention was made with Government support under U.S. Department of Energy Cooperative Agreement No. DE-FC26-05NT42403 awarded by the U.S. Department of Energy. The Government has certain rights in this invention.

### BACKGROUND

The present application relates generally to the field of batteries and battery systems. More specifically, the present application relates to a system for packaging and cooling batteries (for example, in a cell assembly or module).

It is known to provide batteries for use in vehicles such as automobiles. For example, lead-acid batteries have been used in starting, lighting, and ignition applications. More recently, hybrid electric and pure vehicles have been produced which utilize a battery (for example, a nickel metal hydride (NiMH) battery) in combination with other systems (for example, an internal combustion engine) to provide power for the vehicle.

Lithium-ion batteries have a higher charge density than NiMH batteries (i.e., a lithium-ion battery can be smaller than an equivalent NiMH battery while still holding the same charge), and therefore occupy less space while accommodating generally similar electrical loads.

It is generally known that lithium-ion batteries perform differently than NiMH batteries. In some applications, it may be desirable to obtain the enhanced power/performance of a lithium-ion battery. For example, lithium-ion batteries may provide greater specific power than NiMH batteries. However, the application of lithium battery technology may present design and engineering challenges beyond those typically presented in the application of conventional NiMH battery technology.

The design and management of a lithium battery system and/or module that can be advantageously utilized, for example, in a hybrid vehicle, may involve considerations such as electrical performance monitoring, thermal management, and containment of effluent (for example, gases that may be vented from a battery cell).

It would be desirable to provide an improved battery module for use in vehicles. It would also be desirable to provide a system for efficiently and effectively cooling battery cells used in the module. It would also be desirable to provide an improved system and method for assembling a battery module. It would be desirable to provide a battery system that includes any one or more of these or other advantageous features as will be apparent from the present disclosure.

### SUMMARY

According to an embodiment, a battery module includes a housing configured to receive a plurality of cells. The housing includes a first tray that includes a plurality of depressions and a second tray coupled to the first tray that includes a plurality of depressions. Each of the plurality of cells is received within a depression of at least one of the first tray and the second tray

According to another embodiment, a battery module includes a housing configured to receive a plurality of cells. The housing comprises a first tray having a plurality of depressions and a second tray matingly coupled to the first tray and having a plurality of depressions. The plurality of cells are received by the plurality of depressions of the first and second trays, and the first and second trays have a plurality of openings that are configured to facilitate a flow of a cooling fluid between the plurality of cells. The first and second trays further comprise a plurality of grooves to receive a first terminal and a second terminal of the plurality of cells.

According to another embodiment, a battery module includes a plurality of cells arranged axially in an end-to-end fashion and a housing surrounding and spaced apart from the plurality of cells. The housing defining at least one space between the housing and the cells through which a heat transfer fluid may flow along the length of the cells to cool the cells.

### BRIEF DESCRIPTION OF THE DRAWINGS

FIG. 1 is a perspective view of a vehicle having a battery system or module provided therein.

FIG. 2A is a partially-exploded perspective view of a battery module for use in a battery system according to an exemplary embodiment.

FIG. 2B is an exploded perspective view of the battery module of FIG. 2A with three rows of cells omitted.

FIG. 3 is a perspective view of the assembled battery module of FIG. 2A.

FIG. 4 is a front elevation view of the assembled battery module of FIG. 2A.

FIG. 5 is a top plan view of the assembled battery module of FIG. 2A.

FIG. 6 is a rear elevation view of the assembled battery module of FIG. 2A.

FIG. 7 is a cross-sectional view of the assembled battery module of FIG. 2A.

FIG. 8A is a partial cut-away cooling flow diagram of the assembled battery module of FIG. 2A.

FIG. 8B is a partial cut-away cooling flow diagram of the assembled battery module of FIG. 2A.

FIG. 9 is a front elevation view of the assembled battery module of FIG. 2A with buss bar connections.

FIG. 10 is a schematic perspective view of a battery module for use in a battery system according to an exemplary embodiment.

FIG. 11 is a schematic elevation view of the battery module of FIG. 10.

FIG. 12 is a perspective view of a tray of a battery module according to an exemplary embodiment.

FIG. 13 is an overhead plan view of a tray of the battery module of FIG. 12.

FIG. 14 is a side elevation view of a tray of the battery module of FIG. 12.

FIG. 15 is a perspective view of a tray for use in a battery module according to another exemplary embodiment.

FIG. 16 is a perspective view of a vehicle according to another exemplary embodiment.

### DETAILED DESCRIPTION

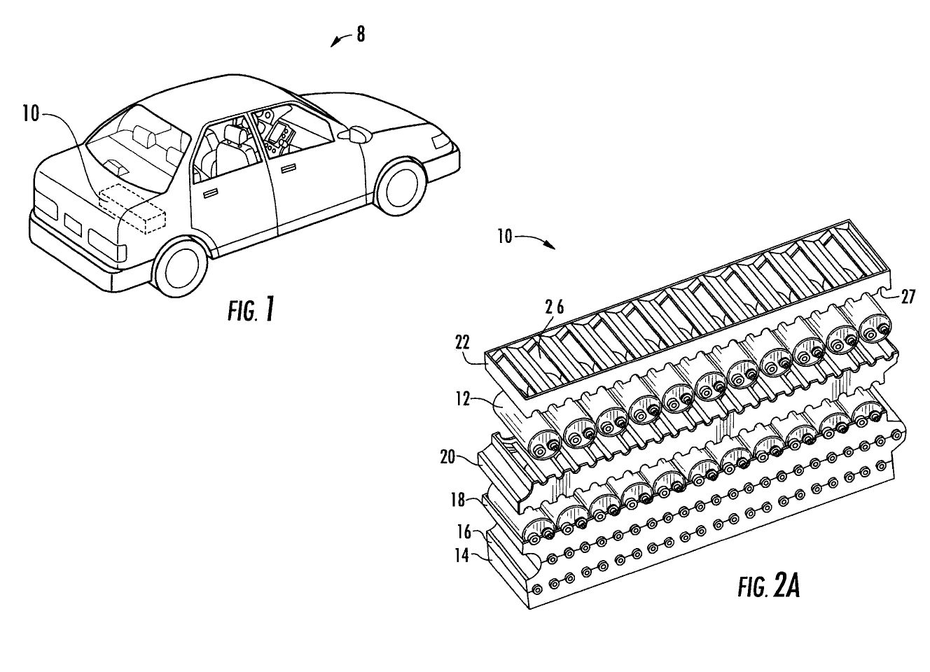

The batteries and systems described herein may be used in any of a variety of applications, including, for example, vehicles such as hybrid electric vehicles and plug-in electric vehicles and electric vehicles. FIG. 1 is a perspective view of a vehicle 8 (for example, a hybrid-electric vehicle (HEV) or plug-in HEV (PHEV)) having a battery module provided therein according to an exemplary embodiment. The size, shape, and location of the battery module or system and the type of vehicle may vary according to a variety of other exemplary embodiments.

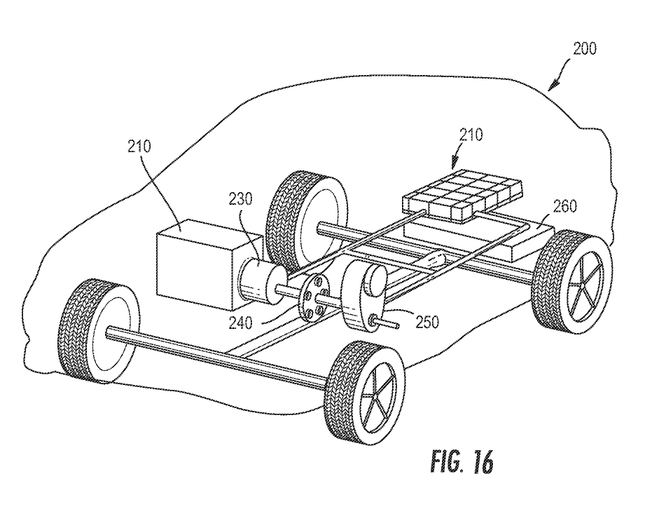

One example of the manner in which the battery system or module is integrated within a vehicle is illustrated according to an exemplary embodiment illustrated in FIG. 16. As shown therein, a vehicle 200 (e.g., a hybrid electric vehicle) is shown according to an exemplary embodiment. Vehicle 200 includes a battery system 210 (e.g. lithium-ion battery system), an internal combustion engine 220, an electric motor 230, a power split device 240, a generator 250, and a fuel tank 260. Vehicle 200 may be powered or driven by just the battery system 210, by just the engine 220, or by both the battery system 210 and engine 220. It should be noted that other types of vehicles and configurations for the vehicle electrical system may be used according to other exemplary embodiments.

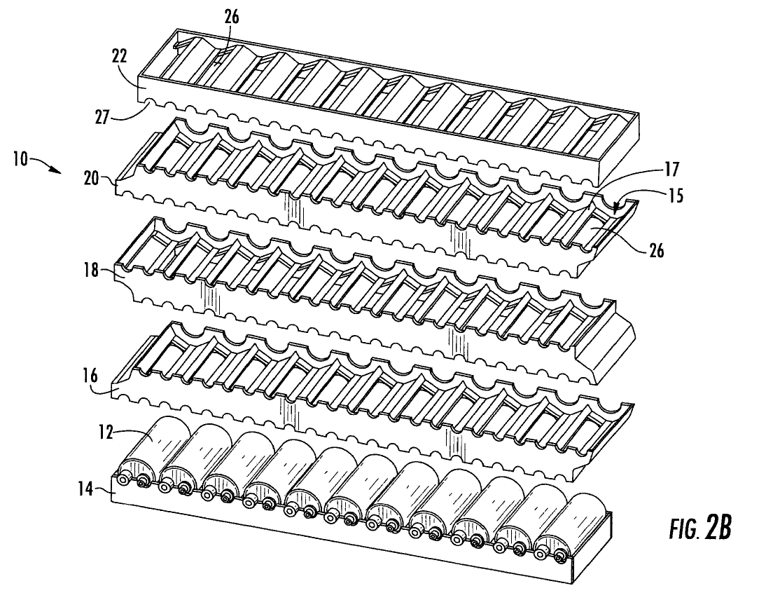

Referring to FIGS. 2A and 2B, a battery module 10 includes a plurality of batteries or cells 12 and a plurality of members or elements shown as trays 14, 16, 18, 20, and 22. Between each of the trays 14, 16, 18, 20, and 22 is provided a row of cells 12 (as shown, for example, in FIG. 2B, where one row of cells 12 is provided in tray 14; the other rows of cells have are not shown between the trays for clarity) such that the trays sandwich the cells therebetween.

Each of the trays 14, 16, 18, 20, and 22 are configured to receive a row of battery cells 12. Each of the batteries 12 in the row fit into or are received by a depression, valley, trough, cradle, or channel 15 and an upper portion, protrusion or peak 17 defined by the trays 14, 16, 18, 20, and 22 (see, for example, tray 20 in FIG. 2B—similar configurations are provided for each of the trays).

The tray 16, which has a different configuration than tray 14 as shown in FIG. 2B, is provided on top of the first row of cells 12 and is configured for coupling or mating with the tray 14 to retain the row of cells in place. A second row of cells 12 is then provided on tray 16 in the depressions or channels defined by the tray 16.

The tray 18 is configured for mating or coupling both with tray 16 and to sandwich the second row of cells between the trays 16 and 18. A third row of cells 12 is provided on tray 18.

Tray 20 is configured for coupling or mating with the tray 18 and for sandwiching the third row of cells between the trays 18 and 20. A fourth row of cells 12 is provided on tray 20.

Tray 22, which has a similar or identical configuration to the tray 14, is configured for coupling or mating with the tray 20 and for sandwiching the fourth row of cells 12 between the trays 20 and 22.

According to an exemplary embodiment, the trays 14 and 22 have a similar or identical configuration. According to an exemplary embodiment, the trays 16, 18, and 20 have a similar or identical configuration. As shown in FIG. 2B, the trays 16, 18, and 20 are arranged in alternating orientations (i.e., the trays are arranged as mirror images of each other in the stack).

It should be understood that according to other exemplary embodiments, the battery module may include any suitable number of rows of batteries or cells and any suitable number of trays of any desired configuration.

Each tray 14, 16, 18, 20, and 22 includes one or more cutouts or openings 26 that are configured to facilitate a flow of a cooling fluid (for example, air, liquid, etc.) between the cells 12 of module 10. Each tray 14, 16, 18, 20, and 22 also defines a number of cutouts or grooves 27 for the terminals 30, 32 (shown in FIG. 4) of each cell 12 to be exposed when module 10 is assembled. Cutouts, openings, or grooves 27 are typically of a specific shape to facilitate proper polarity of the terminals 30, 32 when laying down a row of cells 12 (for example, since the terminals have different sizes and/or shapes, the cells must be oriented in a particular manner in order for the terminals to be properly received in the grooves in a Poka-Yoke manner). In other exemplary embodiments, grooves 27 may be of shapes that are capable of receiving a plurality of different shapes of terminals regardless of polarity.

FIGS. 2A and 2B illustrate a battery module 10 capable of retaining 44 of the cells 12. It should be understood that in other exemplary embodiments, a different number of cells may be utilized in the modules, depending on the number of trays 14, 16, 18, 20, and 22 used and other factors. For example, a base tray (such as tray 14) may be combined with a top tray (such as tray 22) while omitting other trays (for example trays 16, 18, and 20) resulting in a module 10 with a single row of cells 12. In another example, a base tray (such as tray 14) may be combined with a single tray (for example, tray 16) and a top tray (such as tray 22), resulting in a module 10 with two rows of cells 12. In still other examples, modules of greater size than shown in FIGS. 2A and 2B may be assembled by adding alternating layers of trays such as those shown in FIGS. 2A and 2B as appropriate. Likewise, trays 14, 16, 18, 20, and 22 may be of different sizes and have capacity for more or fewer than eleven cells in each row.

Trays 14, 16, 18, 20, and 22 may be made of any generally electrically insulating material (e.g., an injected molded polymeric material such as polyethylene or polypropylene) capable of supporting the cells 12 in a configuration similar to that shown in FIGS. 2A and 2B. Additionally, while the cells shown in FIGS. 2A and 2B are shown as having a generally cylindrical shape, according to other exemplary embodiments, cells may have other forms (for example, oval, prismatic, polygonal, etc.). According to still other exemplary embodiments, cells may be lithium-ion, nickel cadmium, nickel metal hydride (NiMH), or any other suitable types of electrochemical cells.

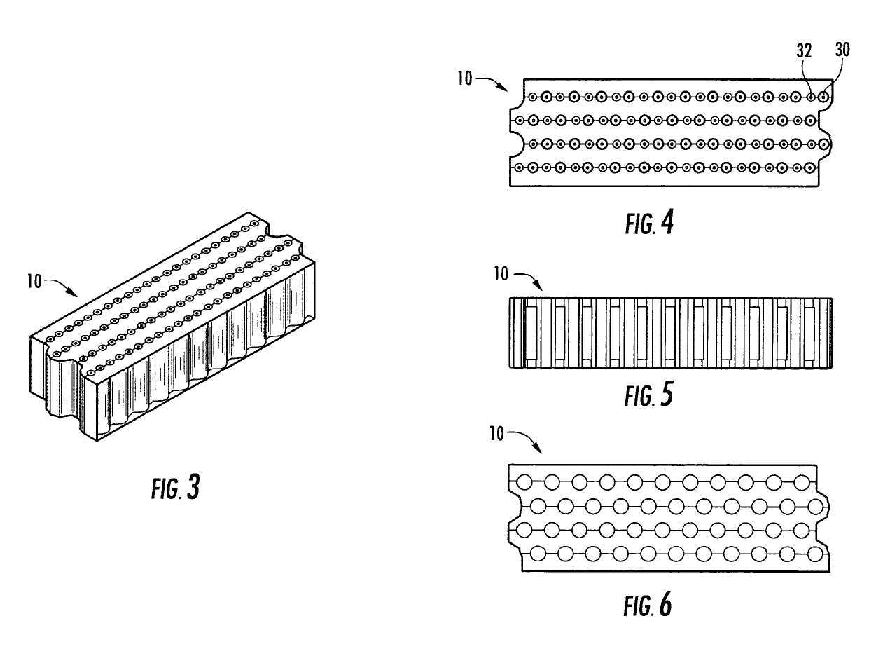

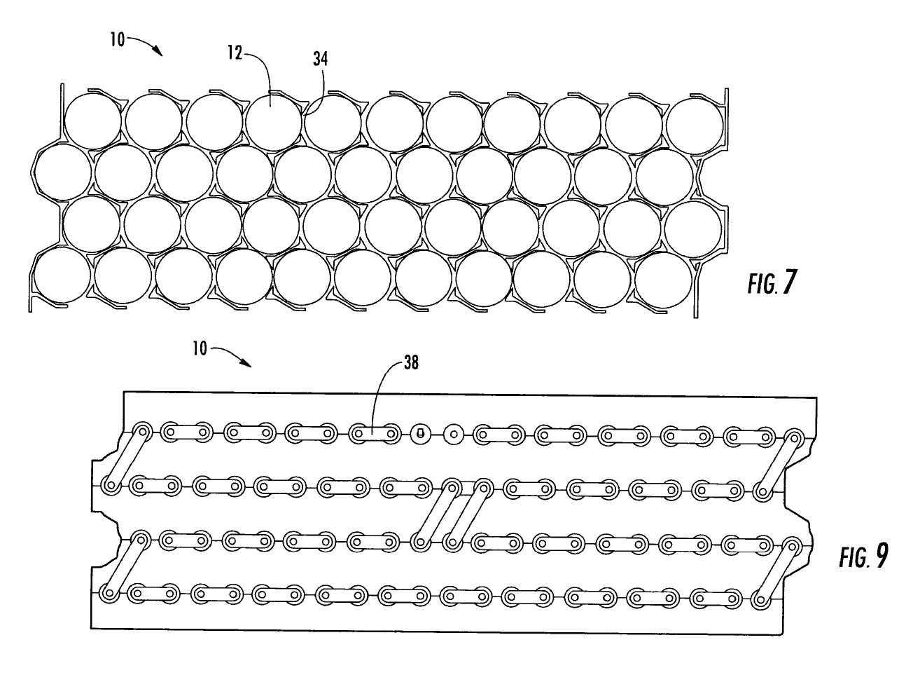

Referring to FIGS. 3-6, an assembled module 10 is illustrated from a number of views. The terminals 30, 32 of cells 12 (as shown in FIG. 4) are exposed for relatively easy access for connecting to a load or to each other. The opposite end of each battery or cell 12 is exposed on the opposite side of the trays as a pathway for the expulsion of gases in the unlikely event that a cell 12 should vent. It should be understood that the module 10 may be oriented in any suitable direction as may be appropriate in a given vehicle application.

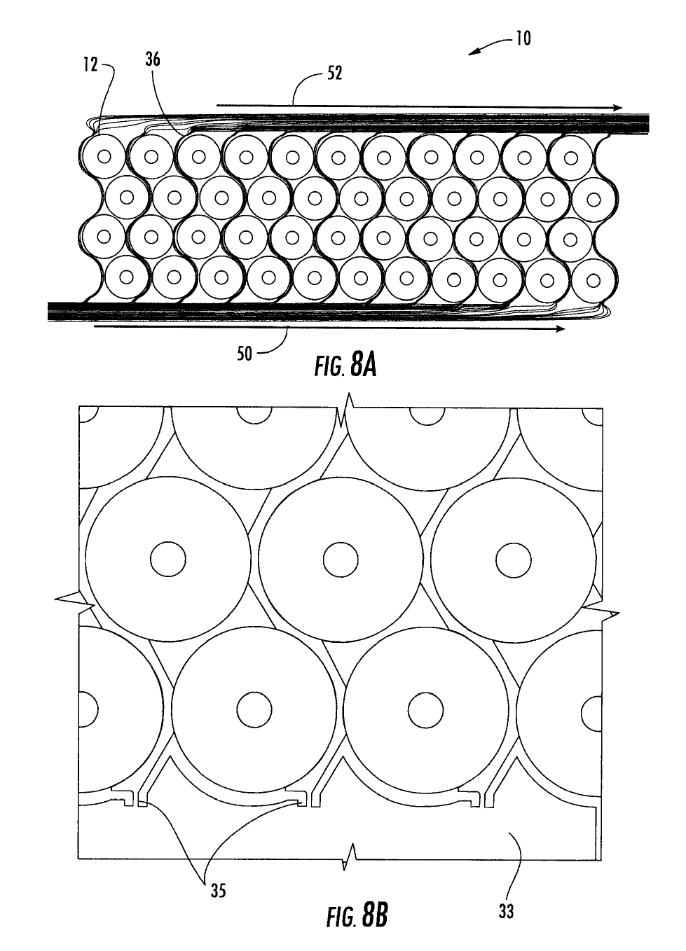

Referring to FIGS. 7-8, an assembled module 10 defines a number of pathways 34 for the flow of cooling fluid (for example, air, liquid, etc.) near cells 12. As shown specifically in FIG. 8, a cooling fluid 36 may be provided to module 10. Cooling fluid 36 may enter module 10 as represented by arrow 50 in FIG. 8A. Cooling fluid 36 may be at a high velocity. As shown in more detail in FIG. 8B, the cooling fluid 36 flows from a plenum airspace 33 through inlets or bottlenecks 35 to a multitude of discreet channels or passages formed between cells 12 and trays 14, 16, 18, 20, and 22. The bottlenecks 35 form a restricted opening that creates a pressure drop as the cooling fluid 36 leaves the plenum airspace 33. Having bottlenecks 35 ensures that cooling fluid reaches all the discreet channels 34 at substantially the same temperature. As the fluid 36 flows over cells 12, heat transfer takes place (i.e., the fluid absorbs heat from cells 12) and the fluid 36 exits module 10 as represented by arrow 52. Confining the fluid 36 to discreet channels reduces the chance of the fluid wandering or taking unpredictable paths through the module 10. Confining the fluid 36 to discreet channels further allows greater control of the heat transfer characteristics of the system. Exiting fluid 36 (arrow 52) is at a higher temperature than entering fluid 36 (arrow 50) due to the heat transfer that takes place between the cells 12 and the cooling fluid 36. It is noted that according to various exemplary embodiments, cooling fluid 36 may be pushed into (blown into) or pulled through (sucked out) of module 10 (for example, by a fan, by a pressure difference, by a vacuum pump, etc.).

It is noted that while a specific shape of cooling pathways 34 is shown, pathways of other shapes may be defined based on alternative tray structures and shapes. As shown previously, cells 12 lie in or make contact with trays 14, 16, 18, 20, and 22. In an exemplary embodiment where trays 12, 16, 18, 20, and 22 are at least partially thermally conductive, contact with the material may transport heat from the cells to a state of equilibrium, thus moderating the temperature of individual cells 12 with the temperature of other cells.

Referring to FIG. 9, the terminals of cells 12 in module 10 are electrically coupled in a series configuration via a plurality of buss bars 38. It is noted that other electrically coupled configurations may be formed with external connections at a different position relative to module 10. According to various exemplary embodiments, buss bars 38 may be of any past, present or future design or composition that facilitates the electrical coupling of cells 12.

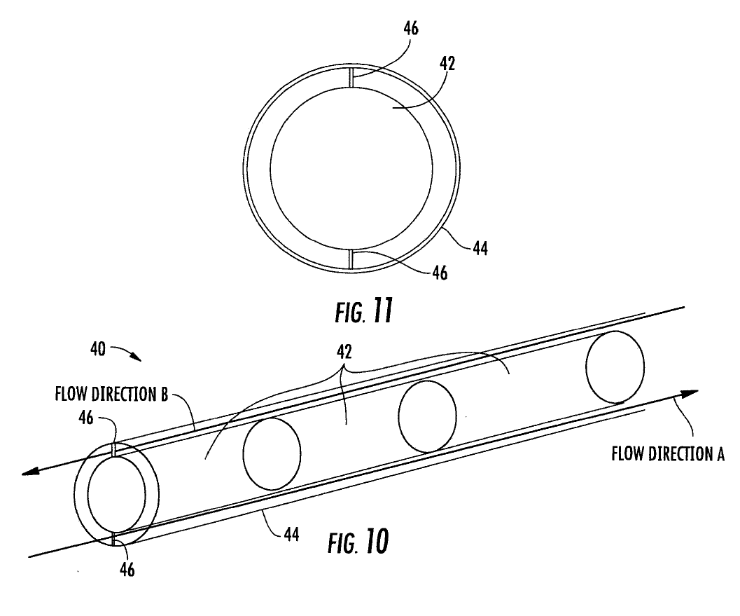

Referring to FIGS. 10 and 11, according to another exemplary embodiment, a module 40 may be assembled that includes a plurality of cells 42 that are stacked axially (end-to-end) and are surrounded by a housing or tube 44. Tube 44 is generally of a larger diameter than cells 42 and is fitted concentrically with cells 42 to provide an annulus for proper heat transfer between the cells 42 and a heat transfer medium (for example, cooling fluid 36). Tube 44 is generally a single unitary body that includes two internal tabs 46. In the exemplary embodiment shown in FIGS. 10 and 11, tabs 46 run the length of tube 44 and are separated from one another (for example, by 180 degrees). The tabs 46 each contact the cell outer walls normal to the tangent point, allowing for the heat transfer medium to be divided into two sections and flow in opposite directions over each side of cells 42 as illustrated by flow direction arrows A and B. This configuration may reduce the temperature of module 40 and create better temperature uniformity as the heat transfer medium flows in series across cells 42. According to another exemplary embodiment, there may be more than two tabs and more than two sections for the heat transfer medium to flow through. The tube 44 may be made from any suitable material, such as, for example, an electrical insulating material.

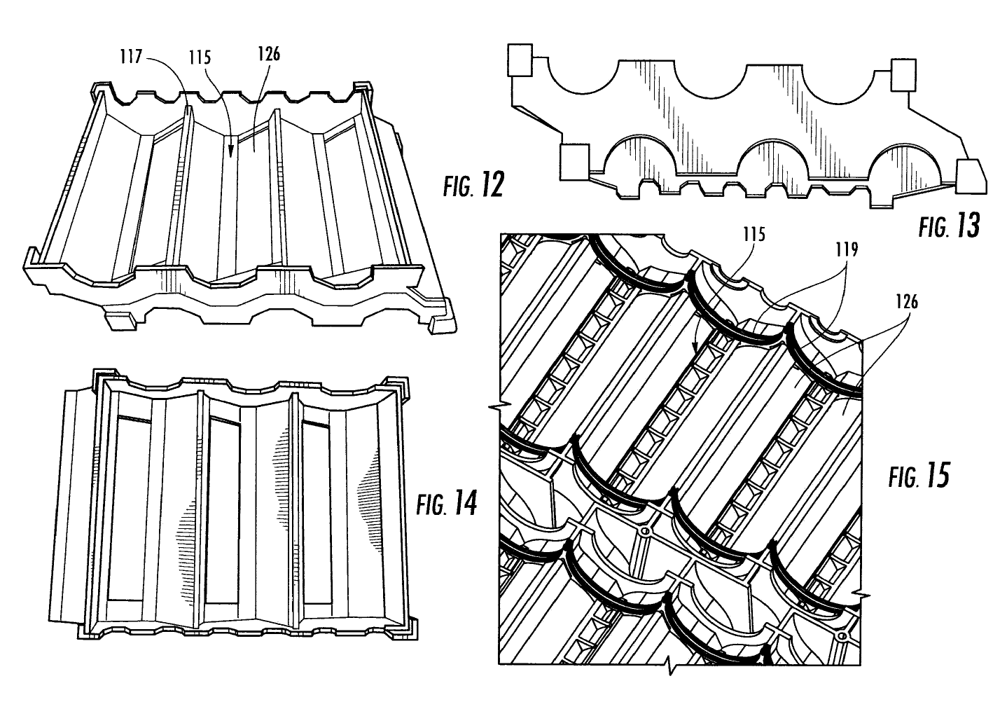

Referring to FIGS. 12-14, various exemplary embodiments of battery trays are illustrated. Such trays are similar to those illustrated in FIGS. 2A and 2B, although each is configured to house six cells (three on top and three on bottom). As described above, other tray configurations are also possible according to various exemplary embodiments. As shown in FIGS. 12-14, the various tray configurations include multiple depressions, valleys, troughs, or channels 115 and upper portions, protrusions, or peaks 117 defined by the trays (see, for example, FIG. 12B—a similar configuration is provided for in each of the trays). Also provided in the various tray configurations are cutouts or openings 126 that are configured to facilitate flow of a cooling fluid between the cells of the module.

Referring now to FIG. 15, a tray is shown according to another exemplary embodiment. Any of the above described trays may further include sealing members 119 as shown in FIG. 15. According to one exemplary embodiment, sealing members 119 are overmolded silicone seals that are configured to resist high temperatures. Sealing members 119 facilitate isolating cooling fluid in discreet channels and keep the fluid isolated from the terminals of the cells 12 and any gasses that might be vented from cell 12.

It should be noted that references to “front,” “rear,” “top,” and “base” in this description are merely used to identify various elements as are oriented in the FIGURES, with “front” and “rear” being relative to the environment in which the device is provided.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is important to note that the construction and arrangement of the battery system as shown in the various exemplary embodiments is illustrative only. Although only a few embodiments have been described in detail in this disclosure, those skilled in the art who review this disclosure will readily appreciate that many modifications are possible (for example, variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present embodiments.

1-20. (canceled)

21. A battery module comprising:
a first tray;
a second tray coupled to the first tray; and
a plurality of electrochemical cells located between and retained by the first and second trays, the first and second trays each including a plurality of channels, each of the plurality of channels configured to retain a single electrochemical cell;
wherein the first and second trays are configured to allow a cooling fluid to flow between the plurality of electrochemical cells and the adjacent first and second trays in discrete passages; and
wherein at least one of the first and second tray includes a plurality of inlets to the discrete passages that are configured to ensure that the cooling fluid enters each of the discrete passages at substantially the same temperature.

22. The battery module of claim 21, wherein the plurality of inlets are provided as part of the first tray and are in fluid communication with an airspace adjacent the first tray.

23. The battery module of claim 22, wherein the airspace is configured to direct the cooling fluid toward the plurality of inlets.

24. The battery module of claim 23, wherein each of the plurality of inlets form a restricted opening to create a pressure drop as the cooling fluid leaves the airspace.

25. The battery module of claim 21, wherein the first and second trays each include a plurality of openings that are aligned with the plurality of inlets to form the discrete passages between the plurality of electrochemical cells.

26. The battery module of claim 21, wherein the first and second trays each comprise a plurality of sealing members, a first set of the plurality of sealing members located adjacent a first end of each of the plurality of electrochemical cells and a second set of the plurality of sealing members located adjacent a second end of each of the plurality of electrochemical cells.

27. The battery module of claim 26, wherein the sealing members comprise silicone.

28. The battery module of claim 27, wherein the sealing members are overmolded to the first and second trays.

29. The battery module of claim 21, wherein the first and second trays further comprise a plurality of grooves to receive a first terminal and a second terminal of each one of the plurality of cells.

30. The battery module of claim 29, wherein the grooves configured to receive the first terminals of the plurality of cells have a different geometry than the grooves configured to receive the second terminals of the plurality of cells to ensure proper installation of the plurality of cells within the first and second trays.

31. The battery module of claim 21, further comprising a third tray coupled to the second tray and configured to contain a plurality of cells between the second tray and the third tray.

32. The battery module of claim 21, wherein the cooling fluid is a gas.

33. The battery module of claim 32, wherein the fluid is air.

34. A battery module comprising:
a housing configured to receive a plurality of cells, the housing comprising:
a first tray having a plurality of depressions;
a second tray matingly coupled to the first tray and having a plurality of depressions; and
a plurality of features intended to balance a flow of a fluid through the plurality of cells;
wherein each of the plurality of cells are received by each of the plurality of depressions of the first and second trays.

35. The battery module of claim 34, wherein the first and second trays comprise a plurality of openings, each one of the plurality of openings of the first and second trays being aligned with each one of the plurality of features to form discrete channels between the plurality of cells to facilitate the flow of the fluid between the plurality of cells.

36. The battery module of claim 35, wherein the housing further comprises a plenum configured to allow the fluid to flow through the features, the features resulting in a pressure drop of the fluid.

37. The battery module of claim 35, wherein the first and second trays comprise a plurality of sealing members configured to substantially seal the fluid in the discrete channels.

38. The battery module of claim 34, further comprising a third tray matingly coupled in between the first and second trays, the third tray having a plurality of depressions on a first side and a plurality of depressions on a second side, wherein the plurality of depressions of the first and third trays are configured to receive a first row of the plurality of cells and the plurality of depressions of the second and third trays are configured to receive a second row of the plurality of cells.

39. The battery module of claim 34, wherein the first and second trays comprise a plurality of grooves to receive a first terminal and a second terminal of the plurality of cells.

40. The battery module of claim 38, wherein the plurality of grooves of the first and second trays are configured in a Poka-Yoke manner such that the first and second terminals of the plurality of cells may only be received by the plurality of grooves in the correct configuration.

41. The battery module of claim 34, wherein the first and second trays are made from a polymeric material.

42. The battery module of claim 41, wherein the polymeric material is selected from the group consisting of polyethylene and polypropylene.

43. A battery module comprising:
a plurality of electrochemical cells arranged axially in an end-to-end fashion; and
a housing surrounding and spaced apart from the plurality of electrochemical cells, the housing defining at least one space between the housing and the cells through which a heat transfer fluid may flow along the length of the cells to cool the cells.

44. The battery module of claim 43, wherein the housing comprises two spaces through which a heat transfer fluid may flow, wherein a first of the two spaces is configured to allow a heat transfer fluid to flow in a first direction along the length of the cells and a second of the two spaces is configured to allow a heat transfer fluid to flow in a second direction along the length of the cells.

45. The battery module of claim 44, wherein the two spaces are separated from each other by walls.

46. The battery module of claim 45, wherein the heat transfer fluid is a gas.

47. The battery module of claim 46, wherein the heat transfer fluid is air.
